(19) United States
(12) Patent Application Publication
(10) Pub. No.: US 2008/0108007 A1
(43) Pub. Date: May 8, 2008

(54) Cosmetic dental apparatus

(75) Inventors: Seong Kon Kong, Olathe, KS (US); Chan Soo Yoo, Los Angeles, CA (US)

Correspondence Address: SEON KON KONG, 706 S. HILL STREET, APT 1214, LOS ANGELES, CA, 90014, US

(73) Assignee: K & Y Jewelry, Inc.

(21) Appl. No.: 11/595,264

(22) Filed: Nov. 8, 2006

(51) Int. Cl. A61C 3/00

(52) U.S. Cl. 433/8

(57) ABSTRACT

A cosmetic dental apparatus for ornamental purpose and does not simulate the appearance of an actual human teeth and gum and a method of wearing the cosmetic dental apparatus is described. A uncured silicone material is placed in the cosmetic dental apparatus wherein the uncured silicone material provides temporarily adhesion to the cosmetic dental apparatus and the wearer's teeth so that the cosmetic dental apparatus remains sufficient stable in the wearer's month until it is removed physically either by hands or through a device for removing the cosmetic dental apparatus. The cosmetic dental apparatus includes an inner portion wherein the inner portion comprises at most three clips for supporting a front portion of the apparatus. The three clips are adjustable. They are adjusted to provide sufficient support so the apparatus may be fitted to the wearer's teeth.

### FIELD OF INVENTION

The present invention relates to cosmetic dental device. Particularly, the present invention relates to a removable cosmetic dental device that is worn for ornamental purpose and does not simulate the appearance of an actual human teeth and gum.

### BACKGROUND

It has become popular in the hip hop culture that a cosmetic dental apparatus featuring metal caps wherein the metal can be silver, gold or platinum and the caps are capable of receiving jewelry such as diamond or crystals. The cosmetic dental apparatus is worn over and cover actual human teeth and gum. The cosmetic dental metal apparatus is worn to reflect a symbol of their wealth and success. Cosmetic dental apparatus is also often referred to as grills, fronts, golds, plates, gold grills, shines, caps, slugs, or pullouts.

The cosmetic dental apparatus can be removable similar to a denture or an orthodontic retainer. Although cosmetic dental apparatus does not simulate the appearance of an actual human teeth and gum, it can be worn as a removable device to cover up missing teeth. While cosmetic dental apparatus is often made of metal, it may also be made of non-metal material including acrylic polymers commonly used in a denture or an orthodontic retainer.

In addition to being a removable device, the cosmetic dental apparatus can also be semi-affixed, similar to how a retainer is affixed to human teeth. For the purpose of this application, removable cosmetic dental apparatus will be discusses.

A simplified method to wear the cosmetic dental apparatus is needed. In addition, a low cost method of producing the cosmetic dental apparatus including the material used, to lower the cost of each product is also warranted.

### SUMMARY OF THE INVENTION

It is an objective to provide a method that a wearer can easily wear the apparatus.

It is another objective to lower the manufacturing cost by using as less material as possible.

It is another objective to provide a method wherein the wearer can wear the cosmetic dental apparatus comfortably.

### BRIEF DESCRIPTION OF THE FIGURES

Various embodiments are illustrated by way of example and not by way of limitation in the figures of the accompanying drawings in which like references indicate similar elements. It should be noted that references to “an,” “one,” or “various” embodiments in this disclosure are not necessarily to the same embodiment, and such references mean at least one.

FIG. 1A illustrates an inner portion and an outer portion of the device wherein the inner portion includes a plurality of clips according to an embodiment of the invention.

FIG. 1B illustrates an inner portion and an outer portion of the device wherein the inner portion is linear and does not include clips according to an embodiment of the invention.

FIG. 2A illustrates a side view of an inner portion and an outer portion of the device wherein the inner portion includes at most three clips according to an embodiment of the invention.

FIG. 2B describes the height and width of a clip according to an embodiment of the invention.

FIG. 2C illustrate a side view an inner portion and an outer portion of the device wherein the inner portion is linear and does not include clips according to an embodiment of the invention.

FIG. 3A illustrates a method of producing adhesive material including powder raisin and catalyst according to an embodiment of the invention.

FIG. 3B illustrates silicon adhesive material requires hot water according to an embodiment of the invention.

FIG. 3C illustrates silicon adhesive material does not require hot water according to an embodiment of the invention.

FIG. 4A illustrates a method of inserting an adhesive material into the cosmetic dental apparatus according to an embodiment of the invention.

FIG. 5A illustrates placing an adhesive material in between an outer portion and an inner portion of the cosmetic dental apparatus according to an embodiment of the invention.

FIG. 5B illustrates placing an adhesive material on top of the inner portion of the cosmetic dental apparatus according to an embodiment of the invention.

### DETAILED DESCRIPTION

An apparatus for ornamental purpose and does not simulate the appearance of an actual human teeth and gum and a method of wearing the cosmetic dental apparatus are described. A person of ordinary skill in the pertinent art, upon reading the present disclosure, will recognize that various novel aspects and features of the present invention can implemented independently or in any suitable combination, and further, that the disclosed embodiments are merely illustrative and not meant to be limiting.

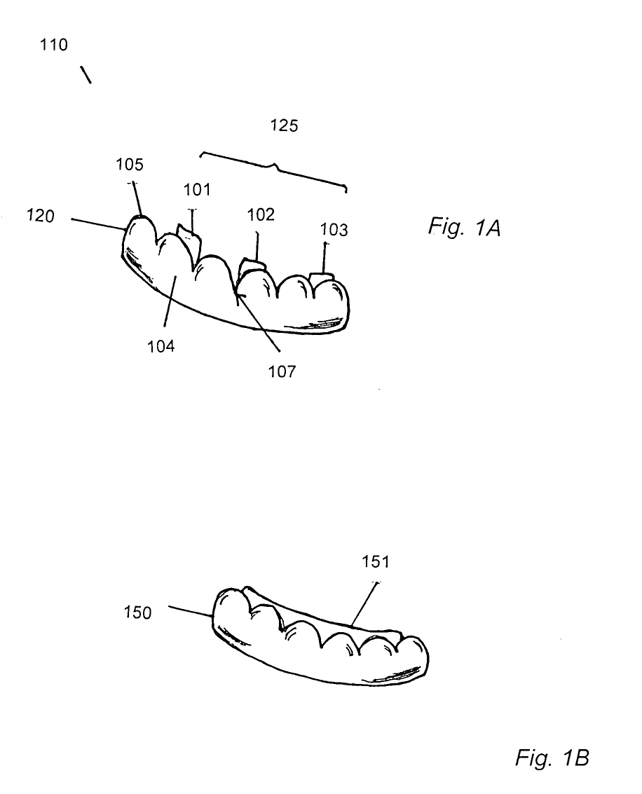

Referring to FIG. 1A, a dental device 110 shown comprises an outer portion 120 and an inner portion 125 wherein the inner portion 125 is nested within the outer portion 120. The inner portion 125 is shaped in such a way that its curvature is substantially parallel to the outer portion 120.

In one embodiment of the invention, the outer portion 120 includes a front section 104 and a top section 105. The front section 104 is capable of receiving a second type of material so that the second type of material may be set or inserted on the front section 104. The second type of material may be of any type material commonly used in connection with jewelry makings. For example, gold, silver, diamond, gemstones, for pearl. It is to be understood that a person of ordinary skill in the pertinent art may choose any material other than those described above to be inserted on the front section 104.

The top section 105 is shaped in a way to include a plurality of raised curves and valleys 107. The shapes of the plurality of raised curvature are designed to resemble of juncture where a tooth and gum meet. This area is often referred to as the cervical area of the marginal gingival. When the device 110 is worn by a wearer, each raised curve covers substantially a tooth. Depending on the number of the raised curves in a particular cosmetic dental apparatus, the number of teeth covered may very.

In a human mouth, the gap between two teeth where covered by gum is referred to as the papilla area. For example, in between two upper front teeth of a person, this papilla area has the shape of an upside down triangle. This area is also referred to as the embrasure. Referring to FIG. 1A, the area or the valley identified by 107 is designed to expose the papilla area of the wearer. Therefore, when the dental device 110 is worn by a wearer, the front section 104 substantially covers the teeth but leaving the wearer's gum exposed. To avoid any discomfort, the thickness of the outer portion 120 may be substantially and approximately 0.5 mm.

The inner portion 125 includes multiple clips. In one embodiment of the invention, the device 105 includes at least one clip. The number of the maximum clips depends on the entire width of the device and how many teeth the device 110 is covering. For example, if the device 110 is covering merely two teeth, then there may not be sufficient space for additional clip. In this example, the device 110 may include only one clip. The primary function of the clip is to provide back support for the outer portion 120 so that when a wearer wears the device 110, the clip or a plurality of clips may be adjusted to minimize the space between the clip or clips and the outer portion 120 to sandwich the teeth between the inner portion 125 and the outer portion 120.

In another embodiment of the invention, the device 110 includes at most three clips. Clips 101, 102, and 103, showed in FIG. 1A, are connected to the outer portion 120 on the end that does not include the raise curves. This embodiment is typically designed for a device that is covering more than two teeth. Because the width of the device is wider, there is sufficient space for the inner portion 125 to include more than one clip. However, as discussed above, the primary function of the clips are to provide back support of the outer portion 120, the number of clips included should be whatever necessary to provide sufficient support. Therefore, it is believed that at most three clips are sufficient to provide the necessary support of the outer portion 120.

Yet in another embodiment of the invention, there are no clips. FIG. 1B illustrates an embodiment wherein the inner portion 151 is linear and does not include any clips. The outer portion 150 is identical to the outer portion 120 discussed in FIG. 1A. Similar to the inner portion 125 discussed in FIG. 1A, the inner portion 151 also provides back support for the outer portion 120. In this embodiment, the inner portion 151 may be made of any material that is capable of been reshaped.

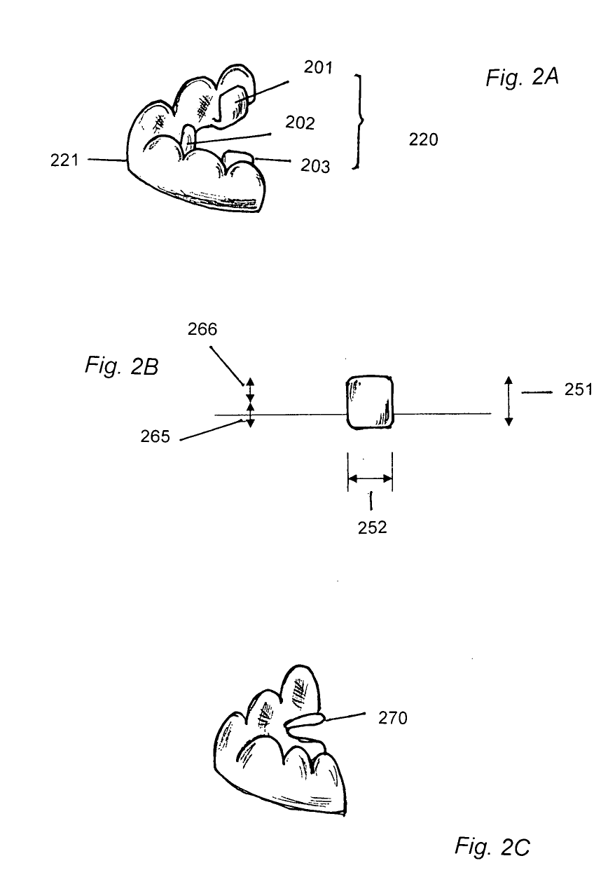

Now referring to FIG. 2A, clips 201, 202, and 203 are adjustable. Before a wearer wears the device 110, the wearer may adjust the clips 201, 202 and 203 so that the gaps between an inner portion 220 and an outer portion 221 are sufficiently large to fit the depth of the wearer's teeth but sufficiently small that the device 110 is fitted tightly on the wearer's teeth.

Clips 201, 202, and 203 may be adjusted by bending the clips forward and backwards relative to the outer portion 221. For example, to make the fitting space smaller, the wearer may bend the clips 201, 202 and 203 forward or towards the outer portion 221 to decrease the space or the gap between the outer portion 221 and the inner portion 220. In another example, to make the fitting space larger, the wearer may bend the clips 201, 202 and 203 backwards or away from the outer portion 221 to increase the space or the gap between the outer portion 221 and the inner portion 220.

A person in the ordinary skill of pertinent art may appreciate that not all the clips are bend equally to provide equal spacing. In one embodiment of the invention, the space or the gap between clip 201 and the outer portion 221, and between clip 201 and the outer portion 221 may be smaller where as the space or the gap between clip 202 and the outer portion 221 may be larger or bigger. This method of shaping may be necessary to fit the device 110 to the particular shape of the teeth of a wearer.

When adjusting clips 201, 202 and 203, these clips remain substantially parallel to the outer portion 221. That is, clips 201, 202 and 203 are sufficiently durable so that the wearer is prohibited from twisting the clips. If the clips are twisted, the twisted clips create an uneven surface and when the wearer wears the device, it creates discomfort. Twisting the clips should be avoided.

The height of the outer portion 221 and inner portion 220 are such that preferably the height of the inner portion 220 is less than half of height of the outer portion 221. Because the primary purpose of the inner portion 220 including at least one clip is to provide support of the outer portion 221, the height of the inner portion 220 may be as small as 2 mm so long the clip is long enough to clip onto the teeth of the wearer.

In addition to the cost efficient advantage because less material is required to produce the device 110, it is safer for the wearer if the height of a clip is less than half of the height of the outer portion 221. This is based on the observation that the height of the back side of a human tooth is generally shorter that the front of the tooth. If the height or the length of the clips is too long, the clips will create a constant irritation to the wearer's gum and may cause health related issues. Therefore, by ensuring that the height of a clip is less than half of the height of the outer portion 221, the clips are not likely to touch the inner gum area when the wearer wears the device.

There are several methods to ensure that when bending or adjusting the clips, the force of a wearer is applied to bending or adjusting the clips forward and backwards, rather than twisting the clips. One of these methods is to ensure that the width of the clips is sufficiently wide. Referring to FIG. 2B, wherein the width of the clip is at least 2 mm. When a clip wherein the width is at least 2 mm, the bottom of the clip is strong enough to receive the force applied by the wearer when the wearer is adjusting the clips so that the clips are bend or adjusted forward and backwards relative to the outer portion 221, rather than twisting the clips.

Another method to ensure the clips are not likely to be twisted when force is applied by the wearer to bend or adjust the clips is having the bottom portion of the clip, section 265 be at least equal width as the upper portion of the clip, section 266.

Another method to ensure the he clips are not likely to be twisted when force is applied by the wearer to bend or adjust the clips is having the bottom portion of the clip, section 265 made of different material than the upper portion of the clip, section 266. The material used in the bottom is preferably softer than the upper portion of the clip.

Referring to FIG. 2C, a linear inner portion 270 may be used instead of multiple clips. In this embodiment, the inner portion 270 may be adjusted to provide sufficient support for the adhesive material and the wearer's teeth.

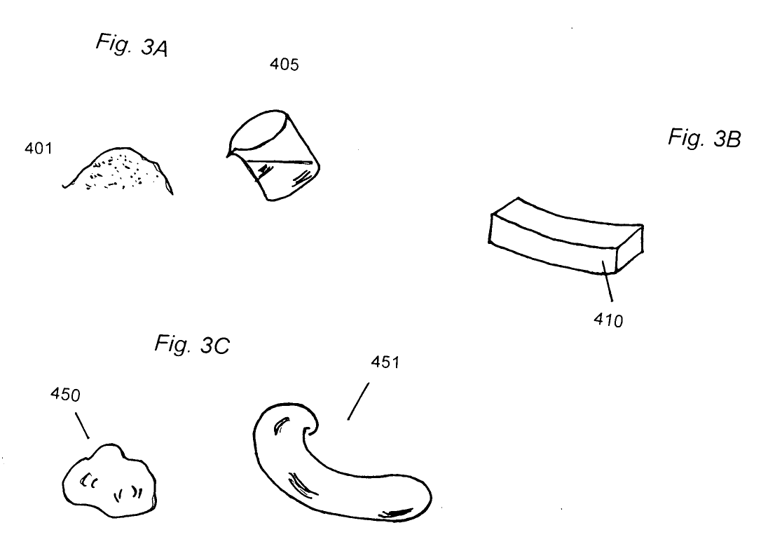

Referring to FIG. 3A, silicone-based polymer systems found sufficiently workable to be molded to the wearer's mouth. Compositions were optimized for setting time and mechanical properties by varying the proportions of catalyst 405, cross-linking agent or base 401, and filler. Mechanical tests showed the optimized silicones to have lower tensile and tear strengths and higher penetration and rebound than most present materials. Detailed measurements of compressive stress-strain, coupled with a stress analysis of conditions in actual use, indicate that the optimized silicone polymers possess more than adequate strength and durability for a user-formed.

The type of catalyst 405 and cross-linking agent or base 401 may be any material used in the dentistry to make imprints. An example of such mixture and fitting method maybe described in U.S. Pat. No., 5,951,291 issued to Albert et al.

Silicones are synthetic polymers made from the products of nature. Although “silicone” is often used as a generic term for nearly all substances that contain a silicon atom, it is more properly described as an entirely synthetic polymer containing a Si—O backbone. To this backbone, organic groups are frequently attached to the silicon atoms via a Si—C bond.

In this embodiment, after an imprint is made, the silicon may not be recurred again to produce a different fitting. This type of fitting method may be preferred to provide custom fitting and to avoid use by different wearers.

Furthermore, the silicon material employed should generally be recognized as safe for use in food or food packaging. According to 21 C.F.R., material that may be used which is safe to the wearer may include, but not limited to, silicone (Si) elastomers containing methyl groups, Silicone (Psi) elastomers containing methyl and phenyl groups, Silicone (Vsi) elastomers containing methyl and vinyl groups, Silicone (Fsi) elastomers containing methyl and fluorine groups, Silicone (PVsi) elastomers containing phenyl, methyl, and vinyl groups.

Referring to FIG. 3B a silicon material is softened by placing it in the hot water. This type of silicon material 410 is cured at room temperature. However, this silicon material may be placed in hot water wherein the hot water is heated up to 150 F and 175 F. After the silicon material is soften or become uncured, it is cooled off until it may be handled by human fingers. After the silicon material is cooled off so it may be handled by human fingers, the uncured silicon is molded so it maybe fitted in between the outer portion and the inner portion of the device.

The silicone material employed in this example to provide adhesive is preferably a reusable silicone. The silicon material maybe cured to provide sufficient adhesion for the device and the wearer's mouth and yet the material maybe uncured so the device may be removed from the wearer's mouth.

Before the uncured silicon material is hardened, the device that includes the uncured silicon material may be placed into the wearer's mouth. The uncured silicon provides a temporary bonding between the device and the wearer's mouth. The temperature inside a wearer's mouth may keep the silicon material from completely cure or harden.

The device including the uncured silicon material maybe removed from the wearer's mouth by physically pulling the device out of the wearer's mouth. The amount of force applied to such removal procedure should be sufficient to remove the device but not to exceed where the removal procedure will cause temporarily or permanently physically and bodily injury to a wearer's mouth and teeth. An example of this material is Ethylene.

Referring to FIG. 3C, an uncured resin is shown where it can be molded by the fingers into the trough so to take shape of the device described above. Another type of silicon material may be used wherein this material remains uncured at room temperature. The uncured material may be contained in any shape depicted by reference number 450. A wearer may mold the uncured resin by rolling the material by the fingers or using a casting device, depicted by reference number 451.

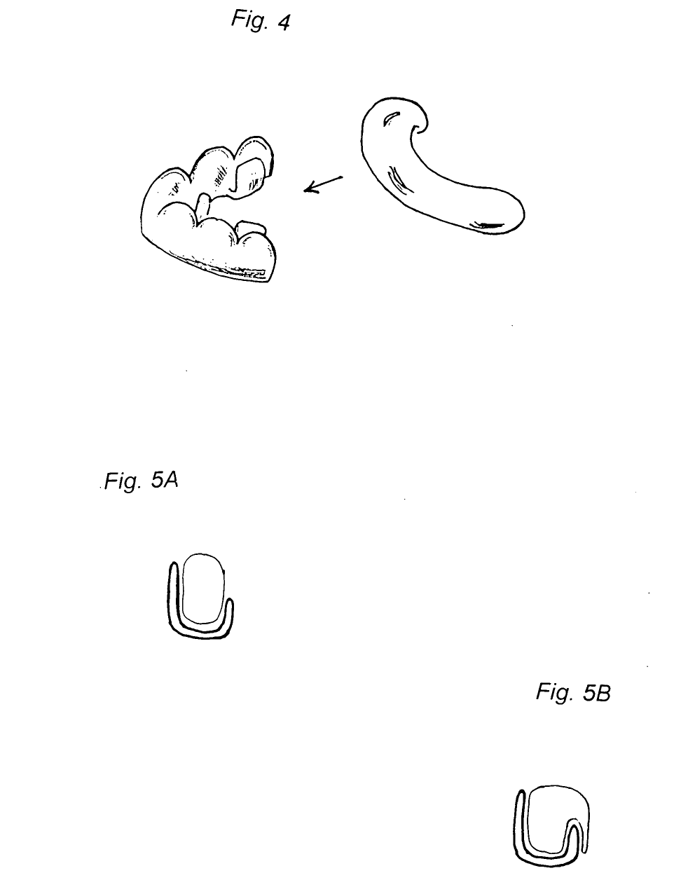

Referring to FIG. 4, the adhesive material described above is placed into the device. After the material is placed in between the outer portion and the inner portion of the device, the device maybe placed into a wearer's mouth. The wearer's teeth are implanted into the silicon material. The silicon material provides a barrier between the device and the wearer's teeth. This protection prevents the device from damaging the wearer's teeth. Because every mouth is shaped different, the silicon material may be used to create a custom fitting. The uncured silicon material may be used to receive different mouth shapes.

Referring to FIG. 5A illustrates a profile of the device where an adhesive material is placed in between an outer portion and an inner portion of the cosmetic dental apparatus according to an embodiment of the invention. In this embodiment, the wearer may feel the inner portion of the device.

Referring to FIG. 5B illustrates a profile of the device where an adhesive material is placed on top of the inner portion of the cosmetic dental apparatus according to an embodiment of the invention. In this embodiment, the wearer may feel the uncured silicon material.

Although the invention has been described in detail hereinabove, it should be appreciated that many variations and/or modifications and/or alternative embodiments of the basic inventive concepts taught herein that may appear to those skilled in the pertinent art will still fall within the spirit and scope of the present invention as defined in the appended claims.

What is claimed is:

1. An apparatus for receiving an adhesive material wherein the apparatuses includes an inner potion and an outer portion, said outer portion includes an upper section and a front section wherein the upper section is curved to assimilate a wave in which teeth and gum meet in a human month.

2. The apparatus of claim 1 wherein the inner portion includes at least one clip.

3. The apparatus of claim 2 wherein the inner portion includes at most three clips.

4. The apparatus of claim 3 wherein the at most three clips has a height shorted that half of a height of the outer portion.

5. The apparatus of claim 2 wherein the at most three clips has uniform width.

6. The apparatus of claim 5 wherein the at most three clips has a minimum of 2 mm width.

7. The apparatus of claim 6 wherein the at most three clips has different material at the bottom

8. The apparatus of claim 7 wherein the at most three clips is adjustable wherein when said at most three clips are adjustable, the said three clips are adjusted forwards and backwards relative to the outer portion.

9. The apparatus of claim 1 wherein the curved upper section further includes even number of raised peaks.

10. An apparatus for receiving an adhesive material wherein the apparatuses includes an inner potion and an outer portion, said outer portion includes an upper section and a front section wherein the upper section is curved to assimilate a wave in which teeth and gum meet in a human month, said inner portion includes at most three clips wherein the at most three clips have a uniform width, the said most three clips are adjustable.

11. An apparatus of claim 10 wherein the adhesive material provides temporarily adhesion to the apparatus and a wearer's teeth.

12. The apparatus of claim 10 wherein the at most three clips has a minimum of 2 mm width.

13. The apparatus of claim 12 wherein the at most three clips has different material at the bottom

14. The apparatus of claim 13 wherein the at most three clips is adjustable wherein when said at most three clips are adjustable, the said three clips are adjusted forwards and backwards relative to the outer portion.

15. An apparatus for receiving an adhesive material wherein the apparatuses includes an inner potion and an outer portion, said outer portion includes an upper section and a front section wherein the upper section is curved to assimilate a wave in which teeth and gum meet in a human month, said inner portion includes a linear upper portion.

16. The apparatus of claim 12 wherein the inner portion includes at most three clips.

17. The apparatus of claim 13 wherein the at most three clips has uniform width. The apparatus of claim 5 wherein the at most three clips has a minimum of 2 mm width.

18. The apparatus of claim 14 wherein the at most three clips has different material at the bottom

19. The apparatus of claim 15 wherein the at most three clips is adjustable wherein when said at most three clips are adjustable, the said three clips are adjusted forwards and backwards relative to the outer portion.

20. The apparatus of claim 12 wherein the curved upper section further includes even number of raised peaks.
